(19) United States
(12) Patent Application Publication
(10) Pub. No.: US 2010/0309007 A1
(43) Pub. Date: Dec. 9, 2010

(54) Garage door message device

(76) Inventor: Stephen Goldsmith, Chino Hills, CA (US)

Correspondence Address: James W. Gipple;Gipple & Hale, P.O. Box 40513, Washington, DC, 20016, US

(21) Appl. No.: 12/387,996

(22) Filed: May 12, 2009

(51) Int. Cl. G08B 21/00

(52) U.S. Cl. 340/644

(57) ABSTRACT

A message sending device mounted under the garage door operating motor whereby a user generated message is projected onto the interior surface of the garage door in conjunction with the operation of the garage door.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to a message sending device for a garage door wherein the display of a message on the interior surface of the door is triggered by operation of the garage door.

### BACKGROUND OF THE INVENTION

The typical American family today is busier than ever. More often than not, both parents work and the children's extracurricular activities ensure that they are rarely, if ever, able to share a meal or otherwise spend time together. Communication is usually a matter of a scribbled note affixed to the refrigerator with a magnet, or a quick e-mail or text message. Similarly, our lives are so tightly scheduled that we often must depend on notes, for example, taped to our computer screens to remind us of important meetings or appointments. These messages are fleeting, quickly forgotten, and can be easily missed. What is needed is an apparatus that will ensure that messages cannot be missed and are seen by the person to whom it is directed. Preferably, that device will also require no change in the routine of the user.

### SUMMARY OF THE INVENTION

The present invention is a message sending device for use with a garage door opener. It is mounted adjacent the opener and triggered by its operation, whereby a message is displayed on the interior surface of the garage door. The message may be selected from pre-programmed messages provided with the apparatus, or may be created by the user using a keypad built into the unit, landline or mobile telephony, a computer, or any other current or nascent technology. The device is preferably provided as an adjunct to be fitted to an existing opener, but this invention also contemplates the device being incorporated into the opener during the manufacturing process.

It is an object of the invention to provide a device for projecting a user selectable and/or programmable message on a garage door.

It is another object of the invention to provide a garage door message sending device that may be installed by the user.

It is yet another object of the invention to provide a household messaging center that is simple and intuitive to use.

It is still another object of this invention to provide a household reminder system.

The invention will be better understood and objects other than those set forth above will become apparent when consideration is given to the following detailed description thereof Such description makes reference to the annexed drawings wherein.

### BRIEF DESCRIPTION OF THE DRAWINGS

FIG. 1 is a bottom plan view of the invention.

FIG. 2 is the remote control of the present invention.

### DETAILED DESCRIPTION OF THE INVENTION

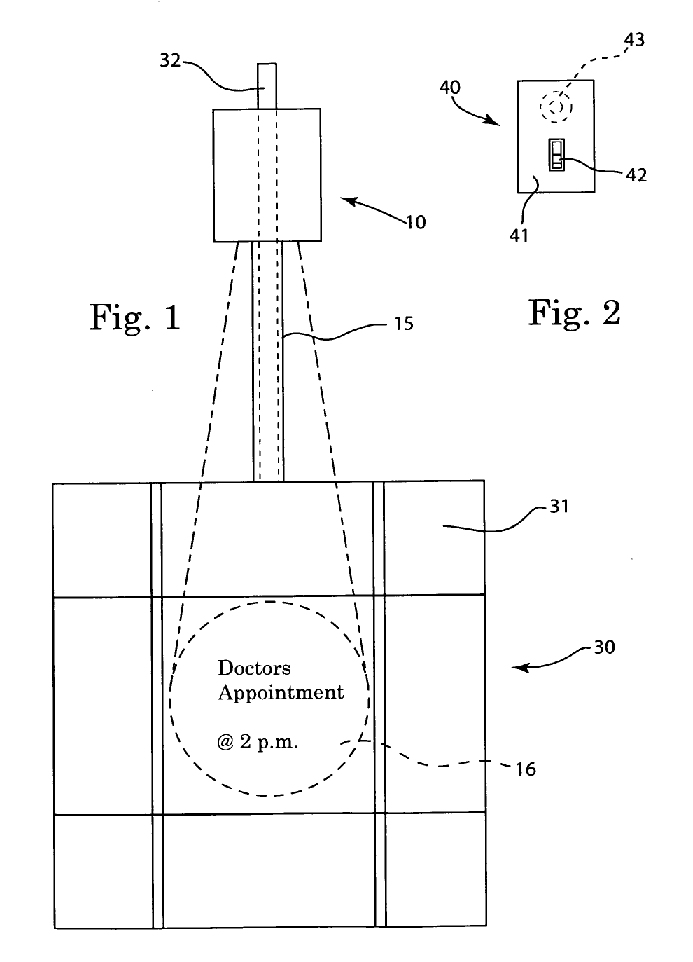

The preferred embodiments and best modes of the invention are shown in FIGS. 1 and 2. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

This invention is constructed from materials suitable for the manufacture of electrical and electronic devices, including visual projection devices. One skilled in the art will understand that these materials include but are not limited electrically conductive circuitry, various lens and materials necessary for projecting an image, and metal, plastic, or other material for the enclosure of the device. The device is retro-fitted to any garage door opener mechanism and includes a replacement garage door opener switch for controlling both the garage door itself and the adjunct message sending device of the present invention.

Turning to FIG. 1, a bottom plan view of the invention is shown, including the message sending device 10 mounted beneath the drive motor of a garage door opener (not shown). The garage door opener motor drive (not shown) and message sending device 10 are themselves mounted beneath the garage door opener track 32. A projection beam 15 emanates from the message sending device 15 whereby a message 16 is projected upon the interior surface 31 of any garage door 30.

FIG. 2 shows the replacement garage door switch 40 of the present invention, including its switchplate assembly 41, switch button 42, and central processing unit (CPU) 43. The CPU 43 comprises a central processor and random access memory (RAM), either in the form of modules incorporated within the switchplate assembly 41 or via a universal serial bus (USB) interface that permits the user to simply insert a so-called “thumb drive” or “flash drive” containing the desired message into the switchplate assembly 41. Also included is a telephonic interface (not shown) whereby the user may optionally “call” the device, either from a landline or mobile cellular telephone, and input a desired message. Additionally, one version includes a keyboard in communication with the CPU.

In use, the user simply programs the desired message into the CPU 43 via 1) a thumb drive / flash drive inserted into its USB interface, 2) “calling” into the device using a landline or mobile cellular telephone, or 3) via its built-in keyboard. Thereafter, pressing switch button 42 causes the aforementioned message to be projected by the message sending device 10, thereby appearing as a projected message 16 on the interior surface 31 of the garage door 30. The projected message 16 is thereafter simply automatically deactivated after a suitable time, for example, 30 seconds, or is deactivated by the closing of the garage door 30.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1) A garage messaging device comprising:
message sending device means mounted adjacent the motor drive of a garage door opener;
a garage door switch; and,
central processing unit incorporated in said garage door switch, said central processing unit in electrical communication with said message sending device, said message sending device projecting a message therefrom.

2) A garage messaging device as claimed in claim 1 wherein said projected message is a user generated projected message.

3) A garage messaging device as claimed in claim 1 wherein said garage door switch is a replacement garage door switch installed in lieu of the previously existing device.

4) A garage messaging device as claimed in claim 3 wherein said replacement garage door switch further comprises a switchplate assembly and switch button.

5) A garage messaging device as claimed in claim 1 wherein said message sending device means further comprises message projection means incorporated therein.

6) A garage messaging device as claimed in claim 1 wherein said central processing unit further comprises a central processor and random access memory means incorporated therein.

7) A garage messaging device as claimed in claim 6 wherein said random access memory means is incorporated into said central processing unit.

8) A garage messaging device as claimed in claim 6 wherein said random access memory means is a universal serial bus interface facilitating insertion of a removable flash memory device.

9) A garage messaging device as claimed in claim 1 wherein said garage door switch further includes a telephonic interface.

10) A garage messaging device as claimed in claim 1 wherein said garage door switch further includes a keyboard in communication with said central processing unit.

11) A garage messaging device comprising:
message sending device means mounted adjacent the motor drive of a garage door opener;
a garage door switch; and,
central processing unit incorporated in said garage door switch, said central processing unit in electrical communication with said message sending device, said message sending device projecting a user generated message therefrom.

12) A garage messaging device as claimed in claim 11 wherein said message sending device means further comprises message projection means incorporated therein.

13) A garage messaging device as claimed in claim 11 wherein said central processing unit further comprises a central processor and random access memory means incorporated therein.

14) A garage messaging device as claimed in claim 13 wherein said random access memory means is incorporated into said central processing unit.

15) A garage messaging device as claimed in claim 13 wherein said random access memory means is a universal serial bus interface facilitating insertion of a removable flash memory device.

16) A garage messaging device as claimed in claim 11 wherein said garage door switch further includes a telephonic interface.

17) A garage messaging device as claimed in claim 11 wherein said garage door switch further includes a keyboard in communication with said central processing unit.
